(19) United States
(12) Patent Application Publication
(10) Pub. No.: US 2004/0162658 A1
(43) Pub. Date: Aug. 19, 2004

(54) Crown out-floor out device for a well service rig

(76) Inventor: Frederic M. Newman, Midland, TX (US)

Correspondence Address: Matthew F. Steinheider, Howrey Simon Arnold & White, LLP, 750 Bering Drive, Houston, TX, 77057, US

(21) Appl. No.: 10/720,594

(22) Filed: Nov. 24, 2003

Related U.S. Application Data
(60) Provisional application No. 60/428,506, filed on Nov. 25, 2002.

(51) Int. Cl. G06F 19/00

(52) U.S. Cl. 701/50; 340/685; 175/40

(57) ABSTRACT

The technology disclosed herein provides a system that calculates traveling block position, traveling block velocity and weight supported by the traveling block. The system takes all these parameters into consideration when slowing and/or stopping the traveling block when it reaches a crown out or floor out position. The result is much safer operation of the traveling block on a workover rig, as well as on an oil drilling rig.

### BACKGROUND OF THE INVENTION

After an oil drilling rig drills a well and installs the well casing, the rig is dismantled and removed from the site. From that point on, a mobile repair unit, or workover rig, is typically used to service the well. Servicing includes, for example, installing and removing inner tubing strings, sucker rods, and pumps. This is generally done with a cable hoist system that includes a traveling block that raises and lowers the aforementioned tubing strings, sucker rods, and pumps.

U.S. Pat. No. 4,334,217 describes a system for monitoring the movement of a travelling block on a drilling rig. As described in the '217 patent, the traveling block can be raised or lowered beyond a safe limit. This is called “crown out” if the traveling block reaches its upper most safe position, and “floor out” if it reaches its lower most safe position. Crown out/floor out can result in equipment damage and/or present a hazard to personnel working on the equipment. Because it is often not possible for the operator of the cable hoist system to see the position of the traveling block, or because the operator can be otherwise distracted from the position of the traveling block, the operator can inadvertently exceed safe positions of the traveling block.

The '217 patent identified the problem of unsafe hoist operation, and proposed a solution in which the total distance traveled by the traveling block is measured, and then compared with a reference point, such as the uppermost (crown) and lowermost (floor) position, of the traveling block. An electronic system was provided for displaying the position of the traveling block to the operator of the hoist system. In the event the operator failed to stop the traveling block from exceeding its uppermost and lowermost position, the system automatically switched off the hoist equipment if those limits were exceeded.

Although the '217 patent set out to solve the problem of unsafe hoist operation in an oil drilling rig, many drawbacks still remain when applying the '217 patent technology to a workover rig. For instance, hoist systems of workover rigs are much faster than those in oil drilling rigs, and the '217 system is not responsive enough to prevent the faster moving traveling block from crowning out or flooring out. Furthermore, the automatic switch-off system of the '217 patent provides for an abrupt stopping of the hoist system and traveling block. Abrupt stopping can cause an unsafe condition during workover operations and can possibly cause equipment damage, as the traveling block often supports a large amount of weight, often in excess of 100,000 pounds.

### SUMMARY OF THE INVENTION

The present invention improves on the '217 patent technology by providing a system that is both safer and more useful on workover rigs. The technology disclosed herein provides a system that calculates traveling block position, speed, weight, and momentum before applying a braking system to slow down and eventually stop the traveling block. The system takes these parameters into consideration when slowing and/or stopping the traveling block when it reaches a crown out or floor out position. The result is much safer operation of the traveling block on a workover rig, as well as on an oil drilling rig.

### BRIEF DESCRIPTION OF THE DRAWINGS

FIG. 1 is a side view of a workover rig with its derrick extended

FIG. 2 is a side view of a workover rig with its derrick retracted.

FIG. 3 illustrates the raising and lowering of an inner tubing string.

FIG. 4 illustrates one embodiment of the present invention.

FIG. 5 shows a schematic of traveling block control for preventing floor out.

FIG. 6 shows an alternate embodiment of traveling block control for preventing floor out.

FIG. 7 shows a further alternate embodiment of traveling block control for preventing floor out.

FIG. 8 shows a schematic of traveling block control for preventing crown out.

FIG. 9 illustrates a simple block diagram of one embodiment of the control system of the present invention.

FIG. 10 shows a simple schematic diagram of the crown out/floor out/momentum governor system of the present invention.

FIG. 11 sets forth a logic diagram showing how one embodiment of this system operates.

FIG. 12 illustrates one embodiment of a momentum governor chart.

### DESCRIPTION OF ILLUSTRATIVE EMBODIMENTS

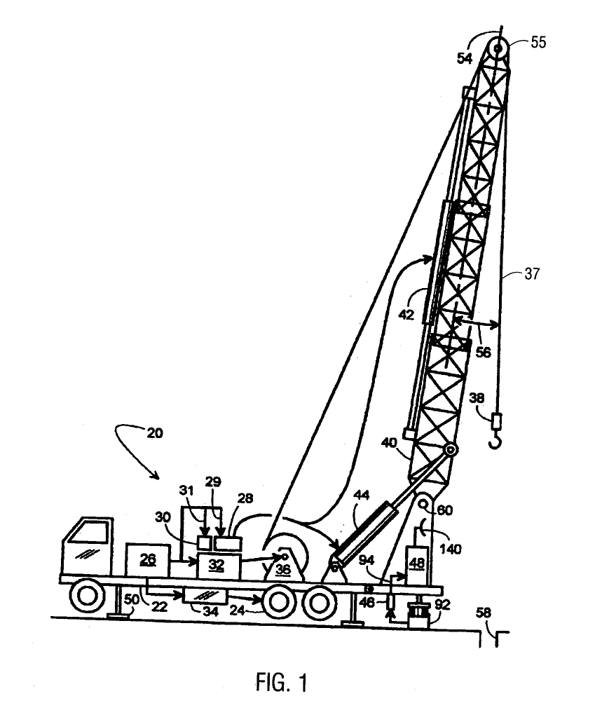

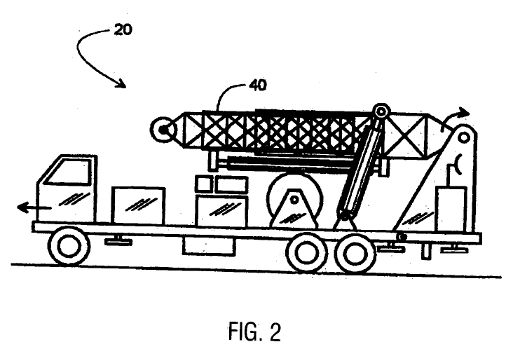

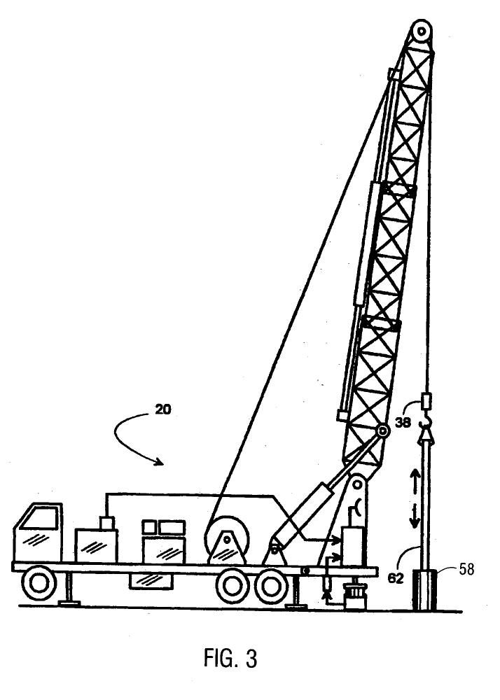

Referring to FIG. 1, a retractable, self-contained workover rig 20 is shown to include a truck frame 22 supported on wheels 24, an engine 26, a hydraulic pump 28, an air compressor 30, a first transmission 32, a second transmission 34, a variable speed hoist 36, a block 38, an extendible derrick 40, a first hydraulic cylinder 42, a second hydraulic cylinder 44, a monitor 48, and retractable feet 50. Engine 26 selectively couples to wheels 24 and hoist 36 by way of transmissions 34 and 32, respectively. Engine 26 also drives hydraulic pump 28 via line 29 and air compressor 30 via line 31. Compressor 30 powers a pneumatic slip (not shown), and pump 28 powers a set of hydraulic tongs (not shown). Pump 28 also powers cylinders 42 and 44 that respectively extend and pivot derrick 40 to selectively place derrick 40 in a working position (FIG. 1) and in a retracted position (FIG. 2). In the working position, derrick 40 is pointed upward; but its longitudinal centerline 54 is angularly offset from vertical as indicated by angle 56. This angular offset 56 provides block 38 access to a well bore 58 without interferences from the derrick framework and allows for rapid installation and removal of inner pipe segments, such as inner pipe strings 62 and/or sucker rods (FIG. 3).

When installing inner pipe segments, the individual pipe segments are screwed together using hydraulic tongs (not shown). Hydraulic tongs are known in the art, and refer to any hydraulic tool that can screw together two pipes or sucker rods. During make up operations, block 38 supports each pipe segment while it is being screwed into the downhole pipe string. After that connection, block 38 supports the entire string of pipe segments so that the new pipe segment can be lowered into the well. After lowering, the entire string is secured, and the block 38 retrieves another pipe segment for connection with the entire string. Conversely, during breakout operations, block 38 raises the entire string of pipe segments out of the ground until at least one individual segment is exposed above ground. The string is secured, and then block 38 supports the pipe segment while it is uncoupled from the string. Block 38 then moves the individual pipe segment out of the way, and returns to raise the string so that further individual pipe segments can be detached from the string.

Referring back to FIG. 1, weight applied to block 38 is sensed, for example, by way of a hydraulic pad 92 that supports the weight of derrick 40. Generally, hydraulic pad 92 is a piston within a cylinder, but can alternatively constitute a diaphragm. Hydraulic pressure in pad 92 increases with increasing weight on block 38, and this pressure can accordingly be monitored to assess the weight of the block. Other types of sensors can be used to determine the weight on the block, including line indicators attached to a deadline of the hoist, a strain gage that measures any compressive forces on the derrick, or load cells placed at various positions on the derrick or on the crown. While the weight of the block can be measured in any number of ways, the exact means of measurement is not critical to the present invention, however it is important that the weight on the block is measured.

Hoist 36 controls the movement of a cable 37 which extends from hoist 36 over the top of a crown wheel assembly 55 located at the top of derrick 40, supporting travelling block 38. Hoist 36 winds and unwinds cable 37, thereby moving the travelling block 38 between its crown wheel assembly 55 and its floor position, which is generally at the wellbore 58, but can be at the height of an elevated platform located above wellbore 58 (not shown). The position of the traveling block between its crown and floor position must always be monitored, such as by the system described in the '217 patent, incorporated herein by reference.

The '217 patent system comprises a magnetic pick-up device or other electrical output type sensor is operatively situated adjacent to a rotary part of the cable hoist 36 or crown wheel assembly 55 and produces electrical impulses as the part rotates. Alternatively, a photoelectric device is used to generate the necessary electric impulses. These electrical impulses are conveyed to electronic equipment that counts the electrical impulses and associates them with a multiplier value, thereby determining the position of the traveling block. While the '217 patent describes one method of measuring the position of the traveling block, other methods are just as useful to the present invention, such as a quadrature encoder, an optical quad encoder, a linear 4-20 encoder, or other such devices known in the art. The means of sensing the position of block 38 is not important to the present invention, however it is important that the position of the block is measured and known.

Once the position of the traveling block is known, the speed of the traveling block can be easily calculated by the system described herein. For example, in is simplest form, the speed of the traveling block can be calculated by determining the traveling block position at a first point, then determining the traveling block position at a second point, calculating the distance therebetween, and dividing the distance traveled by the elapsed travel time. If a pulsed system is used, such as a quadrature encoder or an optical encoder, to determine block position, the speed can be calculated by counting the number of pulses per unit time. If a 4-20 device is used to calculate block position, the rate of change of current per unit time would need to be calculated to determine block speed, where the current is the output of the 4-20 encoder.

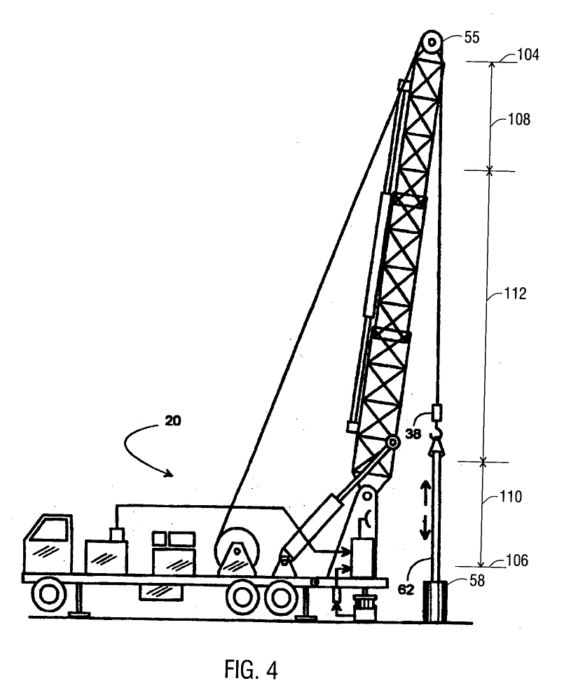

Once the weight, speed and position of the traveling block is known, the traveling blocks can be safely slowed and smoothly stopped by a braking system that takes into account these variables before applying the brakes to the traveling blocks. When seeking to prevent crown out, the system first senses the velocity and vertical position of the traveling blocks. Depending on which region (position) the blocks are in (FIG. 4), the processor compares the actual velocity to the maximum allowed velocity for that region. If the velocity is below the maximum allowed value, for example 2 feet per second in region 108 or maybe 4 feet per second in center region 112, then nothing happens. If on the other hand, the block velocity exceeds the desired maximum velocity for that particular region, the system can either alarm the operator he is going to fast, take away the operator's throttle authority thus slowing the blocks down, throttle the engine down to a point where the speed is reduced to an acceptable level, or any combination of or all of the above. This methodology allows the crew to operate at full horsepower pulling heavy loads at full RPM at any point along the axis of 104-106 so long as a safe operating speed limit is maintained. Each zone of travel, 108, 112, and 110, will have a maximum traveling block speed, with the middle zone 112 having a maximum speed that is greater than that of the slowing down zones 108 and 110.

On the other hand, if the ascending velocity is greater than the predetermined value, than the system automatically signals the throttle controller to slow the speed of upwards travel, regardless of the set-point provided to the throttle controller by the workover rig operator. Slowing the engine blocks down as the blocks enter into region 108 inhibits over travel as the blocks are moving slow enough to be stopped before reaching the predetermined upper limit, thereby avoiding crown out. The system can provide for an obligatory slowing down zone (region 108) in which the maximum block velocity in this region is slower than that of region 112 and is limited to a velocity which allows and accounts for intrinsic delays created by the processing time, brake action time, and on the stopping distance between the entry of the block into region 108 and the crown. In other words, there is a time factor inherent in the system for the system to sense the speed of the traveling blocks, process the data, start the braking action, and then for the drum to actually apply the brakes. In some embodiments, this time is about one half of a second, but it is within the skill of those in the art to determine what this lag time is for each individual system. The end result is that the system is allowed adequate time to slow and stop the blocks before they reach the crown out or floor out positions. Regardless of the block velocity, when the block reaches a predetermined upper limit as shown in FIG. 4 as upper point 104 (Upper Travel Limit), the system will automatically stop the traveling block's upward movement, by reducing the engine to an idle, releasing the drum clutch, and setting the drum parking brake.

A further embodiment of the present invention as it pertains to preventing crown out is a “failsafe” omni reading metal detector located near the crown of the rig. In one embodiment, this detector is a Banner S 18M. When this metal detector is properly wired to the rig, which is within the skill of one familiar with such detectors, it provides an auxiliary means of stopping traveling block travel when it nears a crown out position. When placed in series with the clutch, engine throttle, and brake actuators, for example, if the detector senses metal (the traveling block), it opens the clutch, throttle, and brake circuits, thereby stopping the upward movement of said blocks. Therefore, if the processor or encoder fails during normal operation, the detector becomes a final safety device for stopping the traveling block. The detector should be set and calibrated so it will not to trip when the blocks are traveling in the normal derrick operating region, but will trip, and therefore open the circuits, when the blocks get too close to the crown, regardless of whether the encoder or processor are active or are operating normally. Thus, in the event of a processor failure, a total electrical failure, an encoder failure or other type of system failure, the metal detector will still prevent the traveling blocks from running into the crown:

When the block is traveling downwardly through region 108 and 112, if the velocity is below a predetermined or calculated maximum regional value, for example 8 feet per second, nothing happens. When the blocks travel into lower region 110 which is near the lower stopping point 106, the maximum allowable velocity is reduced, but again, as long as the measured velocity in that region is below the set limits, nothing happens. The maximum downward velocity in regions 104 and 108 can be input into the control system as a predetermined value, or alternatively can be calculated by a simple algebraic equation. This type of equation can take on many forms, but in one simple form this equation takes into account the weight and momentum of the traveling block. Since weight can be measured at (92), we can compute the maximum allowed velocity based on the hookload dividing the maximum allowed momentum figure by the weight, as shown below:

### Velocity max=Momentum(max)/Traveling Block Weight

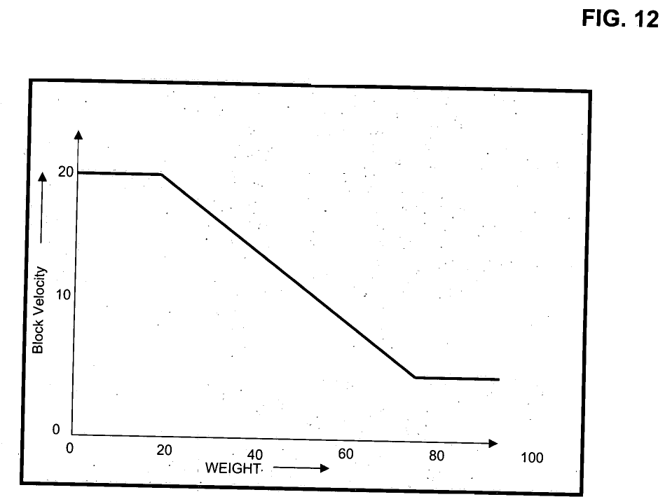

In some embodiments, the weight can be measured and referenced to a predetermined block velocity vs. block weight chart as can be seen in FIG. 12. In this embodiment, once the weight is calculated, the system can refer to the chart to determine the maximum allowed block velocity of downward travel in regions 104 and 108.

Conversely, if the if the traveling block is traveling at a velocity higher than a predetermined value, the system then takes into consideration both traveling block velocity and weight before slowing down the block. For example, if the weight is 40,000 pounds, and the velocity is greater than a predetermined value, for example 2 feet per second, then at a predetermined height a signal is sent to start slowing down the downward travel of the block, so that by the time the block reaches its lowest point, it can be completely stopped before flooring out.

In one embodiment, the velocity of the traveling block is proportional to the weight on the traveling block. For instance, if at 40,000 pounds weight, the predetermined velocity limit could be 2 feet per second, whereas at 50,000 pounds the predetermined velocity limit would be lower, and at 30,000 pounds the predetermined velocity limit would be higher. This effectively calculates the momentum of the traveling block before taking into effect when how the traveling block should be slowed. In another embodiment, a single weight limit and single speed limit could be used for ease of calculation. In another embodiment, the system can allow the block to travel freely throughout the lower range if little or no weight is sensed on the traveling block.

In one embodiment, the traveling block is slowed using a pneumatic brake attached to a proportional valve. For example, if the predetermined protected range of travel is 10 feet above the lower travel limit, then at 10 feet the proportional valve can apply 10% of the air pressure to the brake. At 9 feet, the proportional valve can apply 20%, at 8 feet 30%, and so on until when the block reaches the lower travel limit a full 100% of the brake is applied and the traveling block comes to a smooth stop.

Referring now to FIG. 4, a workover rig is shown with the block supporting a string of tubing. The blocks total travel is between the crown of the hoist 55 and the floor at the well head 58. A point before crown out is the upper limit of travel 104 where the traveling block will be completely stopped by the system. A point before floor out is the lower limit of travel 106 where the traveling block will also be completely stopped by the system. A range below the upper limit is the upper protected travel range 108. As described above, in this range if the velocity exceeds a predetermined value, a signal is sent to the engine governor to slow down the velocity of the traveling block so that when it reaches its upper limit of travel 104 it can be safely stopped. Similarly, a range above the lower limit is the lower protected travel range 110. As described above, in this range the velocity and weight (if desired) is measured, and if the velocity or momentum of the traveling block exceeds a predetermined value, a signal is sent to the brake to begin slowing down the traveling block so that when it reaches its lower limit 106 it can be safely stopped.

In some embodiments, the operator is provided with an override button so that, if necessary, operator control can be maintained over the block throughout the entire range of travel without the automatic control system taking over.

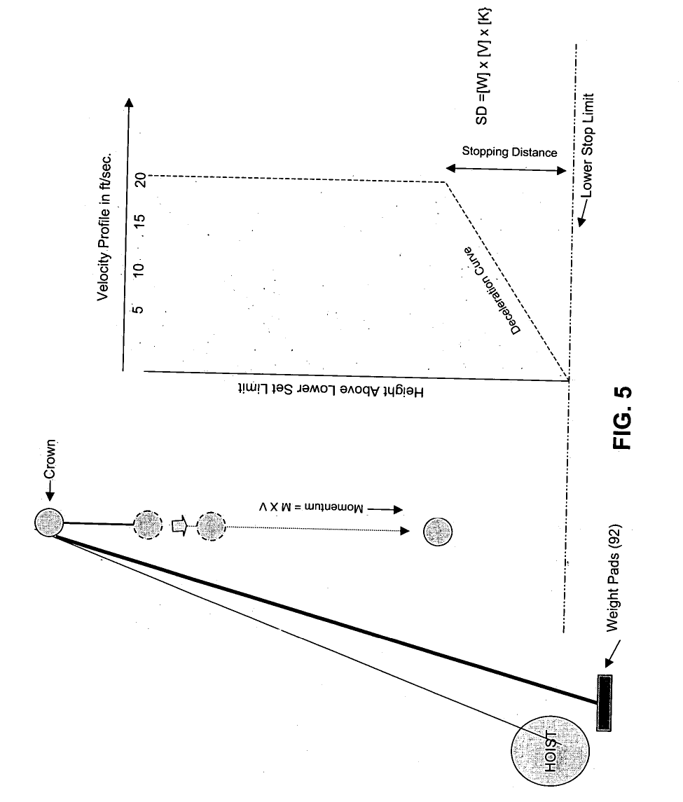

Referring now to FIGS. 5-9, a further embodiment of the present invention is shown in graphical form. When the block is traveling down, as shown in FIG. 5, the momentum of the block could be calculated by multiplying the weight on the block by the speed, or velocity, of the block. The distance needed to bring the load to a full stop will increase as the momentum increases. Therefore, a stopping distance “SD” is calculated by multiplying the momentum of the block times a “K” value, which is simply an input in the control system that is breaking the block. The rig mounted control system calculates the stopping distance based on this equation. The stopping distance is defined herein as the distance above the lower stop limit of the block. The lower stop limit is the lowest point at which the block is allowed to travel, and will usually be set in the control system by the rig operator.

Referring first to FIG. 5, the block is shown to be moving down at a speed of 20 feet per second. If the hookload is, for example, 100,000 pounds and a K value of 0.00001 s/lb is used by the computer, the stopping distance SD would be calculated to be 20 feet above the lower stop limit. When the block reaches the calculated stopping distance point, the control system would then send a variable electric signal via a PID loop to the breaking device on the rig. In one embodiment, the electric signal would be sent an electro-pneumatic transducer or proportional valve whose function is to take the electrical signal and output an air pressure proportional to the electrical signal. The output air from is then piped to an actuating air cylinder on the brake, thereby starting the braking action on the block. In one embodiment, a PID controller (proportional integral derivative) is used to slow the block between the stopping distance point to the lower stop limit. A PID controller would simply monitor the velocity or the momentum of the block and send a signal to the aforementioned electro-pneumatic transducer or proportional valve to add or reduce air pressure as needed to stay on the desired deceleration curve, as shown in FIG. 5.

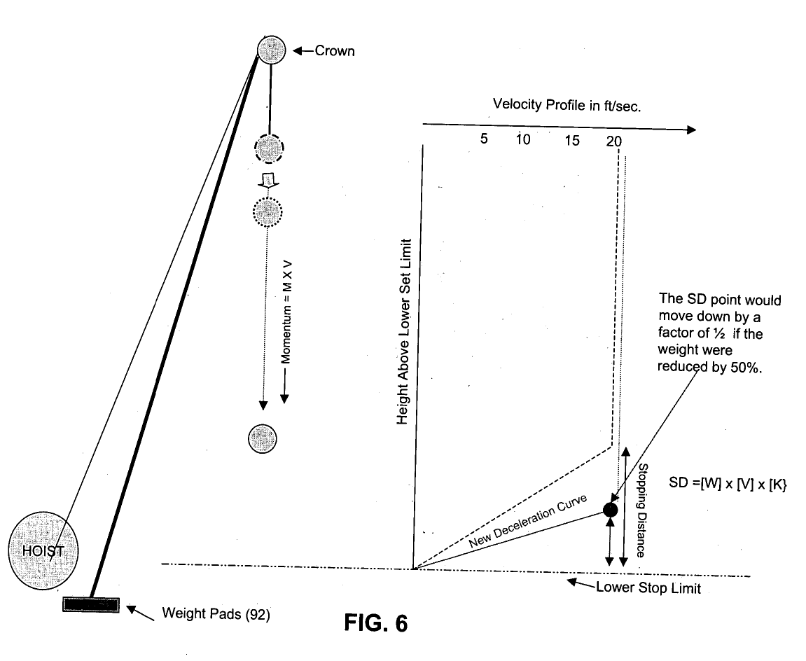

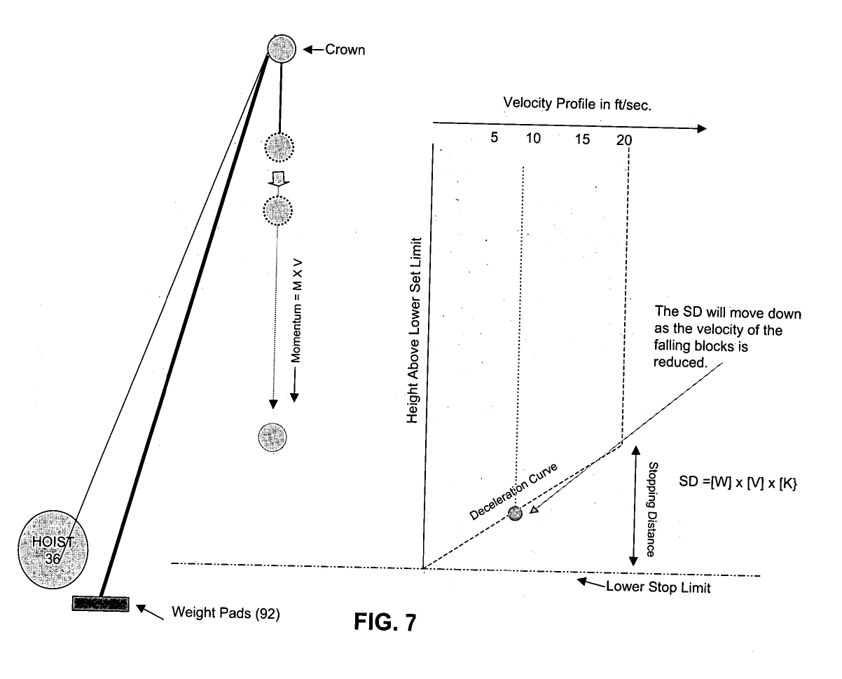

Referring now to FIG. 6, it can be seen that as the weight decreases, the stopping distance point would be closer to the lower stop limit. Comparing FIG. 6 to FIG. 5, if 50,000 pounds was lowered into the hole using the same K-value, both the stopping distance and the slope of the deceleration curve would be half that of lowering 100,000 pounds into the hole. Referring now to FIG. 7, it can be seen that as the velocity decreases while maintaining the same weight on the block, the stopping distance decreases, however the slope of the deceleration curve remains the same. Comparing FIG. 7 to FIG. 5, if 100,000 pounds is being lowered at 10 ft/sec instead of 20 ft./sec at the same K value, the stopping distance would be half that of lowering 100,000 pounds at 20 ft/s, but the slope of the deceleration curve remains the same.

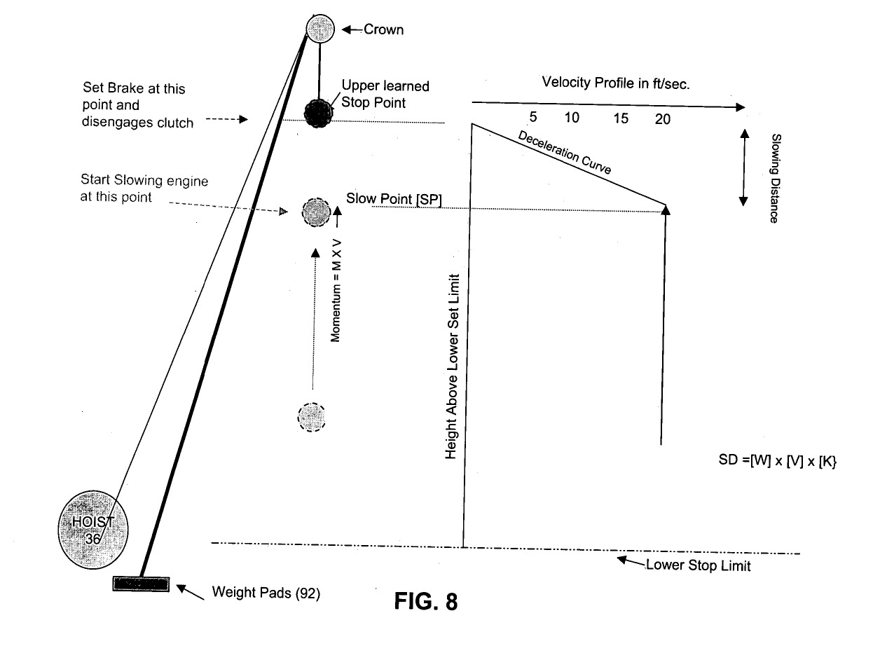

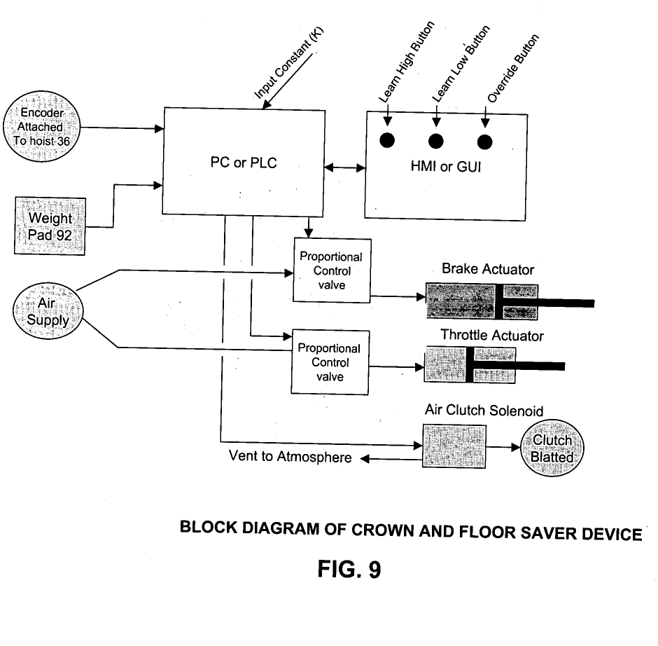

In the hoisting mode, the same general concept is illustrated in FIG. 8. The upward velocity is monitored by the control system, and at some predetermined slow point, which is a point somewhere below the upper most point of travel of the block, the control system initially starts slowing the engine down, thereby slowing to block down. Thus, instead of actuating a brake as in the case of downward block travel, the speed of the hoist is simply slowed so as to slow the block. This can be accomplished by having the control system signal a proportional controller on the engine throttle which, like with the brake, responds proportionally to the control signal to slow the block. The slow point for upward travel is calculated based on block speed, weight, and a K factor, much like the way the stopping distance for downward travel is calculated. In some embodiments, weight may be discarded and only velocity considered to determine the slow point. At the slow point, the control system takes over with a PID controller, keeping the block on the deceleration curve by slowing the engine down. The brake can still be used in upward travel, particularly if the block reaches the upper stop point, or the highest travel position of the block which is set by the operator. Once this position is reached, the control system can set the brake and release the drum clutch, causing the drum to stop rotating and thereby ceasing upward block travel. A simple block diagram outlining the entire system is shown in FIG. 9.

A further embodiment of the present invention involves a momentum governor for the rig. This momentum governor is not only useful to protect crown out and floor out of the traveling block, but also is useful for protecting the rig and crew members from over-stressing the tubulars and the derrick while the rig is running tubulars into the hole. In standard operation, when running into the whole, it is desirable that the traveling block be allowed to fall freely through regions 108 and 112 if lightly loaded, slowing it down or regulating its speed if it is heavily loaded. FIG. 12 illustrates one example of this concept. For instance, if the weight on the traveling blocks is less than 20,000 pounds, they are allowed to travel at speeds up to 20 feet per second. As the hook load gets heavier, the maximum allowed velocity is lowered so as to maintain the momentum of the traveling block within a save envelope. For instance, according to this chart, at 40,000 pounds on the block the maximum downward velocity may be 11 feet per second. Finally, at hook loads above 75,000 pounds, the maximum downward velocity would be around 4 feet per second. This momentum governor would only apply to regions 108 and 112 of FIG. 4, and would have no application in the aforementioned floor out control portion of the crown out/floor out apparatus. Of course, the weights and speeds listed herein are used for example purposes only. The actual values used will differ from rig to rig and will need to be determined by the rig operator before using this momentum governor. The actual values will depend on a number of factors, including type of rig, operating parameters of the rig operator, and the safety level the operator wishes to operate under.

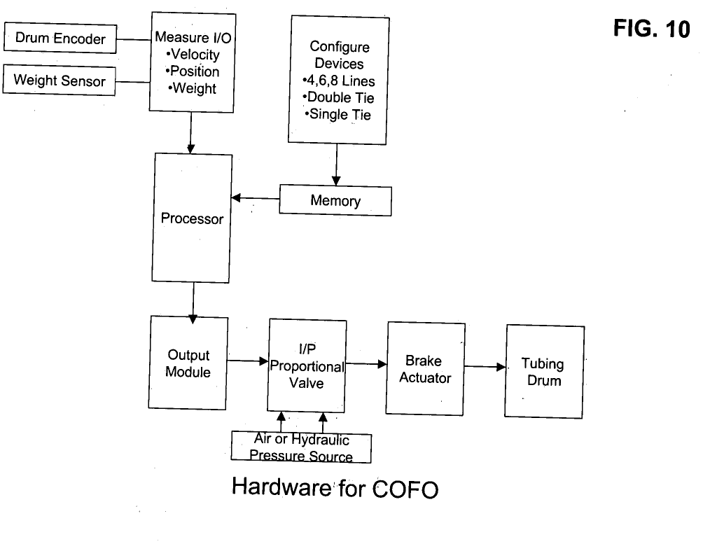

Referring now to FIG. 10, a simple schematic diagram of the crown out/floor out/momentum governor system. Inputs from the tubing drum encoder (or any other block position indicator) and the weight sensor are inputted into the system, and the velocity, position, and weight on the traveling block are then calculated based on the sensor inputs. The system processor, using a PID loop, compares the actual velocity and weight to what is in the system memory. In one embodiment, the system memory is predetermined in separately inputted, however as described above, in a separate embodiment the system memory can be in the form of a chart as shown in FIG. 12. The PID loop, in comparing the actual data to the data in memory, ensures that the system is either on or below the line on the chart or below the predetermined velocity values for its given position.

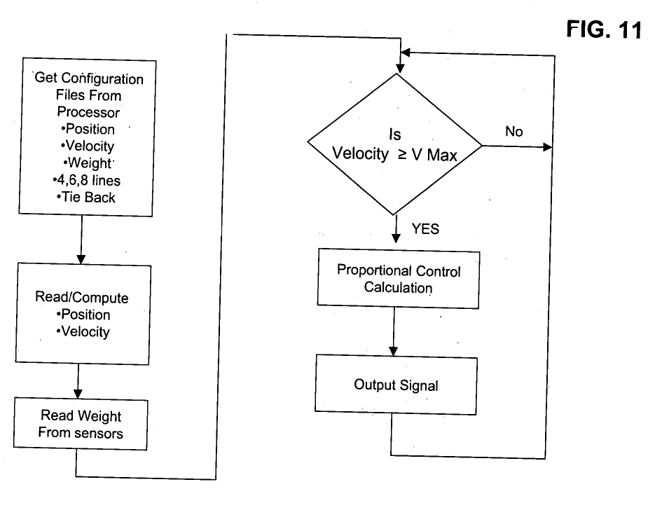

Referring to FIG. 11, a logic diagram showing how this system works is set forth. If the velocity is greater than the maximum allowed, the PID controller sends an output signal to the output module which in turn will actuate the brake to slow the traveling block. This process is repeated until the block stops or reaches the floor out position, or in the case of an ascending traveling block, the loop will retard the throttle to slow the block down. Of course, the maximum velocity will change as the traveling block enters either of the top or bottom slowdown zones.

In one example of this system in application, assume that the operator is running a heavy string of tubing into the hole and exceeds the maximum allowed velocity. If the bottom of the tubing were to stack out on a scale ledge, if only for a moment, if the blocks are descending too rapidly, it will overrun the tubing after the tubing has stopped its downward movement. If the tubing breaks loose, it can fall and cause a sudden impact on the traveling block. This is actually a common occurrence in the field. The force of the free falling tubing, sometimes in excess of 100,000 pounds, can cause significant damage to the rig and tubing, causing an unsafe situation for the operator. Using this system, if the maximum velocity is exceeded, the traveling block is automatically slowed, thereby significantly reducing the chances of this type of catastrophic event by allowing the operator to catch the blocks before they are allowed to overrun the tubing.

In another embodiment of this invention, all near crown or near floor incidents are captured in a data logger. For example, whenever the rig control system takes control of the blocks and stops them because they are too near the stop points, it is captured as an event and stored on a computer resident with the service rig. This event can then be transmitted to a central computer system, making it available to the management of the well service company. Since it is recorded, the well service company will be able to tell if the operator ran the rig dangerously or running it too close to the limits of the rig.

While the apparatuses and methods of the present invention have been described in terms of preferred embodiments, it will be apparent to those of skill in the art that variations may be applied to what has been described herein without departing from the concept and scope of the invention. All such similar substitutes and modifications apparent to those skilled in the art are deemed to be within the scope and concept of the invention as it is set out in the following claims. For instance, many of the embodiments were described as being useful on well service rigs, however each embodiment is equally useful on standard drilling rigs and other types of oil rigs.

What is claimed is:

1. An process for controlling the speed of a traveling block of a well workover rig, comprising:
determining the speed of the traveling block;
comparing the speed of the traveling block to a maximum velocity value; and
adjusting the speed of the traveling block so as to maintain its speed at or below the maximum velocity value.

2. The process of claim 1, wherein the speed of the traveling block is adjusted by slowing down the speed of the engine controlling the traveling block.

3. The process of claim 1, wherein an alarm is sounded when the speed of the traveling block exceeds the maximum velocity value.

4. A process for controlling the speed of a traveling block of a well workover rig, comprising:
determining the speed of the traveling block, the position of the traveling block with a traveling range, and the weight on the traveling block;
comparing the speed of the traveling block to a maximum velocity value, wherein the maximum velocity value is determined as a function of the weight on the traveling block; and
adjusting the speed of the traveling block so as to maintain its speed at or below the maximum velocity value.

5. The process of claim 4, wherein the speed of the traveling block is adjusted by slowing down the speed of the engine controlling the traveling block.

6. The process of claim 4, wherein an alarm is sounded when the speed of the traveling block exceeds the maximum velocity value.

7. The process of claim 4, wherein the maximum velocity value in an upper slow down zone of the traveling range of the traveling block is lower than the maximum velocity value at a point immediately below the upper slow down range.

8. The process of claim 7, wherein the maximum velocity value in the upper slow down zone continually decreases from the bottom of the zone to the top of the zone.

9. The process of claim 7, wherein the length upper slow down zone is proportional to the momentum of the traveling block.

10. The process of claim 4, wherein the maximum velocity value in a lower slow down zone of the traveling range of the traveling block is lower than the maximum velocity value at a point immediately above the upper slow down range.

11. The process of claim 10, wherein the maximum velocity value in the lower slow down zone continually decreases from the top of the zone to the bottom of the zone.

12. The process of claim 10, wherein the length of the lower slow down zone is proportional to the momentum of the traveling block.

13. The process of claim 4, further comprising the steps of sensing when the traveling block has reached an upper most position and stopping the movement of the traveling block when the upper most position is reached.

14. The process of claim 13, wherein the sensing of the upper most position step is accomplished with a metal detector sensing the traveling block.

15. The process of claim 4, wherein the traveling block speed is slowed using a pneumatic brake attached to a proportional valve.

16. The process of claim 4, wherein the traveling range has an upper limit and a lower limit, the process further comprising logging whether or not the traveling block reaches either the upper limit or the lower limit.

17. A process for controlling the momentum of a traveling block comprising:
determining the speed of the traveling block, the position of the traveling block with a traveling range, and the weight on the traveling block;
calculating the momentum of the traveling block;
comparing the momentum of the traveling block to a maximum momentum value; and
adjusting the speed of the traveling block so as to maintain its speed at or below the maximum velocity value.

18. The process of claim 17, wherein the speed of the traveling block is adjusted by slowing down the speed of the engine controlling the traveling block.

19. The process of claim 17, wherein an alarm is sounded when the speed of the traveling block exceeds the maximum momentum value.

20. The process of claim 17, wherein the maximum momentum value in an upper slow down zone of the traveling range of the traveling block is lower than the maximum momentum value at a point immediately below the upper slow down range.

21. The process of claim 20, wherein the maximum momentum value in the upper slow down zone continually decreases from the bottom of the zone to the top of the zone.

22. The process of claim 20, wherein the length upper slow down zone is proportional to the momentum of the traveling block.

23. The process of claim 17, wherein the maximum momentum value in a lower slow down zone of the traveling range of the traveling block is lower than the maximum momentum value at a point immediately above the upper slow down range.

24. The process of claim 23, wherein the maximum momentum value in the lower slow down zone continually decreases from the top of the zone to the bottom of the zone.

25. The process of claim 23, wherein the length of the lower slow down zone is proportional to the momentum of the traveling block.

26. The process of claim 17, wherein the traveling block speed is slowed using a pneumatic brake attached to a proportional valve.

27. The process of claim 17, wherein the traveling range has an upper limit and a lower limit, the process further comprising logging whether or not the traveling block reaches either the upper limit or the lower limit.
